(19) United States
(12) Patent Application Publication
(10) Pub. No.: US 2023/0001559 A1
(43) Pub. Date: Jan. 5, 2023

(54) HAMMER TOOL FOR POSITIONING DUPLEX HEAD NAIL

(71) Applicant: LUCKY BRAND INDUSTRIAL CO., LTD., TAICHUNG CITY (TW)

(72) Inventor: Ying-Chieh CHEN, TAICHUNG CITY (TW)

(21) Appl. No.: 17/367,607

(22) Filed: Jul. 5, 2021

(51) Int. Cl. B25D 1/06

(52) U.S. Cl. CPC B25D 1/06

(57) ABSTRACT

A hammer tool (1) is provided for positioning a duplex head nail (2). The hammer body (10) includes a front end (11) and a rear end (12), and the front end (11) is formed with a first abutting portion (111) and a second abutting portion (112). The hammer head (20) is connected to the front end (11) of the hammer body (10) and formed with a first positioning groove (21) and a second positioning groove (22). The necked section (40) is formed between the hammer body (10) and the hammer head (20), and the necked section (40) is formed with a first accommodating space (41) and a second accommodating space (42). The duplex head nail (2) is optionally positioned in the first nail slot (100) or the second nail slot (200). Therefore, the duplex head nail (2) may be fixed on the predetermined position accurately.

### BACKGROUND

### Technical Field

The technical field relates to a hand tool, and particularly relates to a hammer tool for positioning a duplex head nail.

### Description of Related Art

Generally, fixing object on a location may be accomplished by using a hammer tool to hit a nail into the object and the fixed location for combination. Moreover, when a related-art hammer tool is used to strike the nail, it is necessary to hold the nail with one hand and hold the hammer tool with the other hand to position the nail and hammer it into the fixed location.

However, in the process of hammering the nail with the related-art hammer tool, the hand holding the nail is easily to be hit and work injury occurs. Moreover, when the fixed location is situated on a high position, the users are unable to see the location to position the nail. As a result, the nail may not be accurately fixed on the predetermined position by the hammer. This affects the convenience and operation of the hammer tool in use.

In view of the above drawbacks, the inventor proposes this disclosure based on his expert knowledge and elaborate researches in order to solve the problems of related art.

### SUMMARY OF THE INVENTION

One object of this disclosure is to provide a hammer tool for positioning a duplex head nail. The hammer tool includes a first nail slot or a second nail slot for the duplex head nail to be positioned optionally. As a result, the duplex head nail may be accurately fixed on the predetermined position to enhance the convenience and operation of use.

In the embodiment of this disclosure, a hammer tool is provided for positioning a duplex head nail with a first nail head and a second nail head. The hammer tool includes a hammer body, a hammer head and a necked section. The hammer body includes a front end and a rear end located oppositely, and a first abutting portion and a second abutting portion are disposed on the front end of the hammer body. The hammer head is connected to the front end of the hammer body. A first positioning groove is disposed correspondingly to the first abutting portion, and a second positioning groove is disposed correspondingly to the second abutting portion. The necked section is formed between the hammer body and the hammer head. The necked section is formed with a first accommodating space between the first abutting portion and the first positioning groove, and formed with a second accommodating space between the second abutting portion and the second positioning groove. The first nail head is optionally positioned in the first abutting portion or the second abutting portion, and the second nail head is located in the first accommodating space or the second accommodating space along with the positioning of the first nail head correspondingly.

Comparing to the related art, the hammer tool of this disclosure includes a first abutting portion and a second abutting portion disposed on opposite sides of the hammer body, and a first positioning groove and a second positioning groove are disposed on opposite sides of the hammer head. In additionally, the necked section is formed between the hammer body and the hammer head. The necked section is formed with a first accommodating space between the first abutting portion and the first positioning groove, and formed with a second accommodating space between the second abutting portion and the second positioning groove. Accordingly, a first nail slot and a second nail slot are formed on the upper and lower sides of the hammer tool respectively. As a result, the users may optionally position the duplex head nail in the first nail slot or the second nail slot according to actual condition to enhance the convenience and operation of use.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective schematic view of the hammer tool for positioning a duplex head nail of this disclosure.

FIG. 2 is an operation status of the hammer tool for positioning a duplex head nail of this disclosure.

FIG. 3 is a combination schematic view of the magnetic component of this disclosure.

FIG. 4 and FIG. 5 are schematic views illustrating operation of the hammer tool of this disclosure.

FIG. 6 and FIG. 7 are other schematic views illustrating operation of the hammer tool of this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

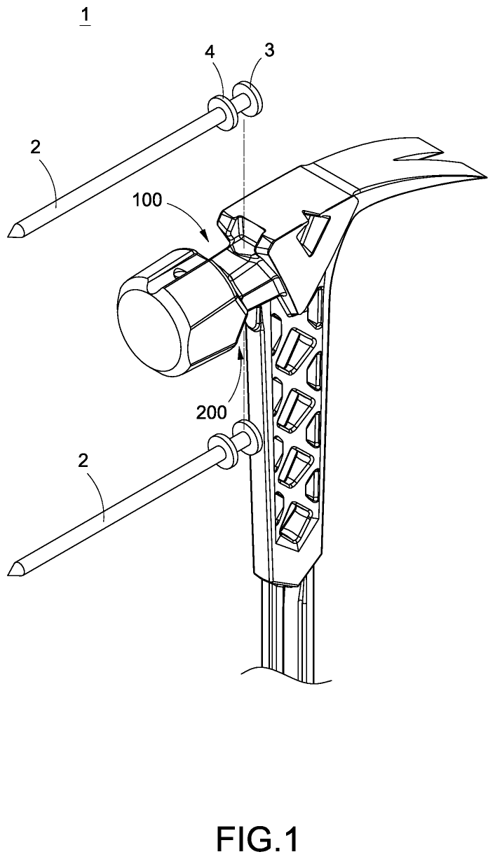

Please refer to FIG. 1, which depicts a perspective schematic view of the hammer tool for positioning a duplex head nail of this disclosure. The hammer tool 1 of this disclosure is provided for positioning a duplex head nail 2, and the duplex nail head 2 includes a first nail head 3 and a second nail head 4 arranged spacedly. It is worth of noticing that the hammer tool 1 includes a first nail slot 100 and a second nail slot 200 on the upper and lower sides respectively. Additionally, the duplex head nail 2 may be optionally positioned in the first nail slot 100 or the second nail slot 200, or the first nail slot 100 and the second nail slot 200 may position a duplex head nail 2 respectively.

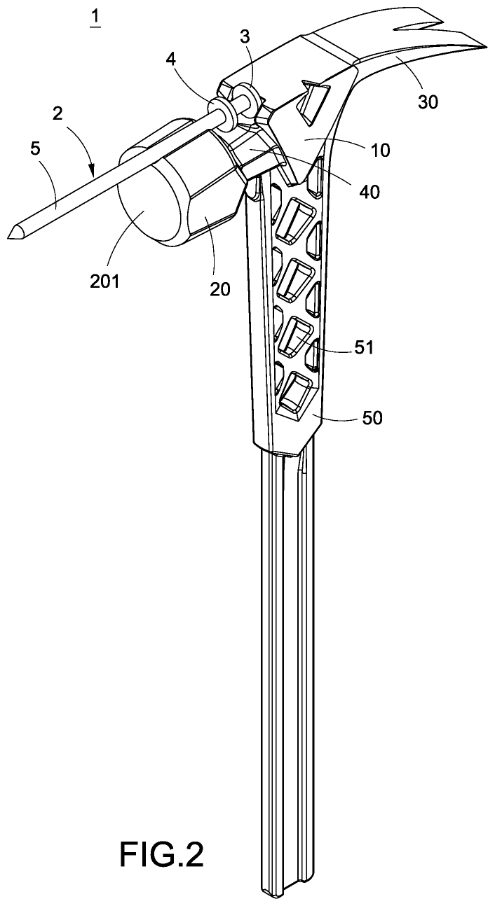

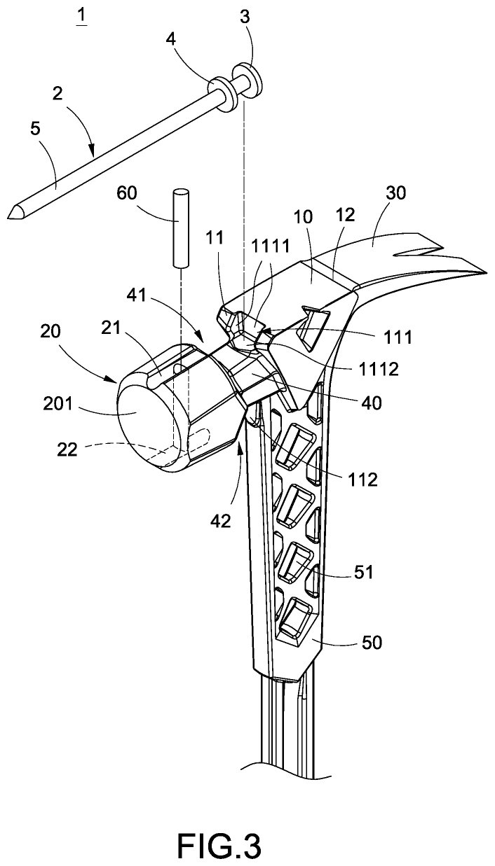

Please further refer to FIG. 2 and FIG. 3, which depict an operation status of the hammer tool for positioning a duplex head nail of this disclosure and a combination schematic view of the magnetic component of this disclosure. The hammer tool 1 of this disclosure includes a hammer body 10, a hammer head 20, a clamping jaw 30, a necked section 40 and a hammer handle 50. The hammer head 20 and the clamping jaw 30 are respectively connected to opposite sides of the hammer body 10, and the necked section 40 is disposed between the hammer body 10 and the hammer head 20. The hammer handle 50 is connected to one side of the hammer body 10 and extended in a direction perpendicular to the hammer head 20 and the clamping jaw 30. More detailed structure of the hammer tool 1 is described as follows.

The hammer body 10 includes a front end 11 and a rear end 12 located oppositely, and a first abutting portion 111 and a second abutting portion 112 are disposed on the front end 11 of the hammer body 10. In this embodiment, the first abutting portion 111 includes a groove, and the second abutting portion 112 is disposed on one side of the hammer handle 50. In the embodiment, the second abutting portion 112 includes a protrusion extended from the hammer handle 50. Moreover, the first abutting portion 111 and the second abutting portion 112 are disposed on opposite sides of the front end 11 of the hammer body 10.

The hammer head 20 is a cylinder and connected to the front end 11 of the hammer body 10. A first positioning groove 21 corresponding to the first abutting portion 111 and a second positioning groove 22 corresponding to the second abutting portion 112 are disposed on the hammer head 20. The first positioning groove 21 and the second positioning groove 22 are disposed on opposite sides of the hammer head 20.

In this embodiment, the front end 11 of hammer head 20 includes a strike face 201. The first positioning groove 21 and the second positioning groove 22 respectively include a long groove disposed on the peripheral surface of the hammer head 20 and extended in the direction from the strike face 201 toward the hammer head 20 to communicate with the necked section 40. Furthermore, the clamping jaw 30 is in a shape of a claw and connected to the rear end 12 of the hammer body 10.

In the embodiment, the necked section 40 is disposed to be a hexagonal prism, such as an octagonal prism. The necked section 40 is formed between the hammer body 10 and the hammer head 20. The necked section 40 is formed with a first accommodating space 41 between the first abutting portion 111 and the first positioning groove 21, and formed with a second accommodating space 42 between the second abutting portion 112 and the second positioning groove 22.

Specifically, the first abutting portion 111 includes a plurality of side walls 1111 located on the hammer body 10 and a bottom wall 1112 communicating with the first accommodating space 41. Additionally, a U-shaped groove is enclosed by the side walls 111 and the bottom wall 1112.

The hammer handle 50 is connected to one side of the hammer body 10 and extended in a direction perpendicular to the hammer head 20. In the embodiment, the hammer handle 50 is provided with a plurality of hollow portions 51 for reducing the overall weight and material to facilitate usage and reduce the material cost. It should be noted that the hammer body 10 and the hammer handle 50 of the hammer tool 1 of this disclosure are integrally formed (or in one-piece form). In some other embodiments, the hammer body 10, the hammer head 20, the clamping jaw 30, the necked section 40 and the hammer handle 50 may be in one-piece form (or integrally formed).

As shown in FIG. 3, the hammer tool 1 further includes a magnetic component 60, such as a magnet, etc. The magnetic component 60 is arranged on the hammer head 10, and the first positioning groove 21 and the second positioning groove 22 are with a magnetic property. In one embodiment of this disclosure, the magnetic component 60 is partially exposed from the first positioning groove 21 and the second positioning groove 22. Thus, the magnetic attraction is generated to the nails in the first positioning groove 21 and the second positioning slot 22. As a result, the nail may not be departed from the first positioning groove 21 and the second positioning groove 22.

Specifically, the magnetic component 60 may be disposed in one-piece form and inserted to the first positioning groove 21 and the second positioning groove 22 which are communicating to each other. In some other embodiments, the number of the magnetic component 60 may be multiple, and the multiple magnetic components are respectively arranged in the first positioning groove 21 or the second positioning groove 22 individually, and the first positioning groove 21 and the second positioning groove 22 are with the magnetic property.

It should be noted that the hammer tool 1 of this disclosure is provided for positioning at least one duplex head nail 2, and the duplex head nail 2 includes a first nail head 3 and a second nail head 4 arranged spacedly. Moreover, the first nail head 3 may be optionally positioned in the first abutting portion 111 or the second abutting portion 112. Additionally, the second nail head 4 is located in the first accommodating space 41 or the second accommodating space 42 along with the positioning of the first nail head 3 correspondingly.

Specifically, the first abutting portion 111, the first accommodating space 41 and the first positioning groove 21 are arranged linearly to form the first nail slot 100. Furthermore, the second abutting portion 112, the second accommodating space 42 and the second positioning groove 22 are arranged linearly to form the second nail slot 200. The duplex head nail 2 may be optionally placed in the first nail slot 100 or the second nail slot 200 according to the needs.

In this embodiment, the duplex head nail 2 is positioned in the first nail slot 100. Furthermore, the first nail head 3 is positioned in the first abutting portion 111, and the second nail head 4 is accommodated in the first accommodating space 41. In addition, the nail body 5 of the duplex head nail 2 is located in the first positioning groove 21 and is positioned by the magnetic component 60.

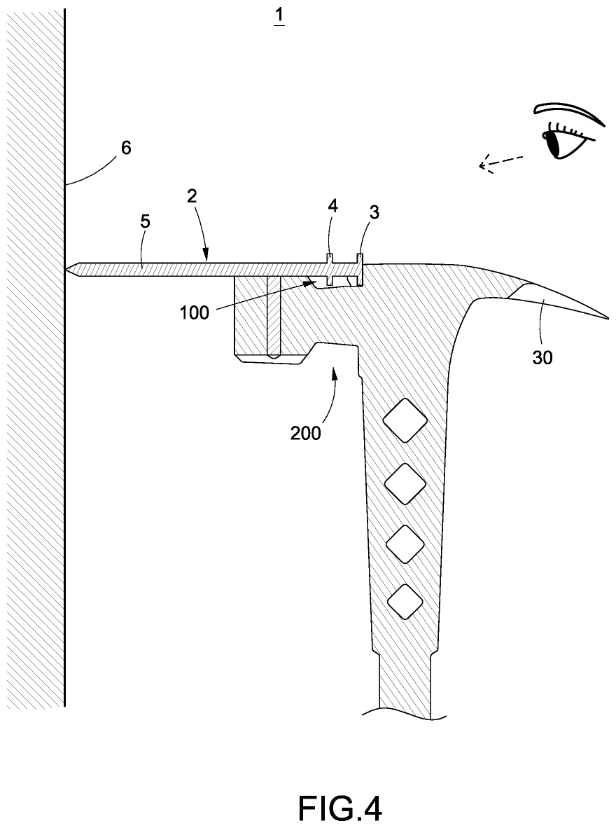

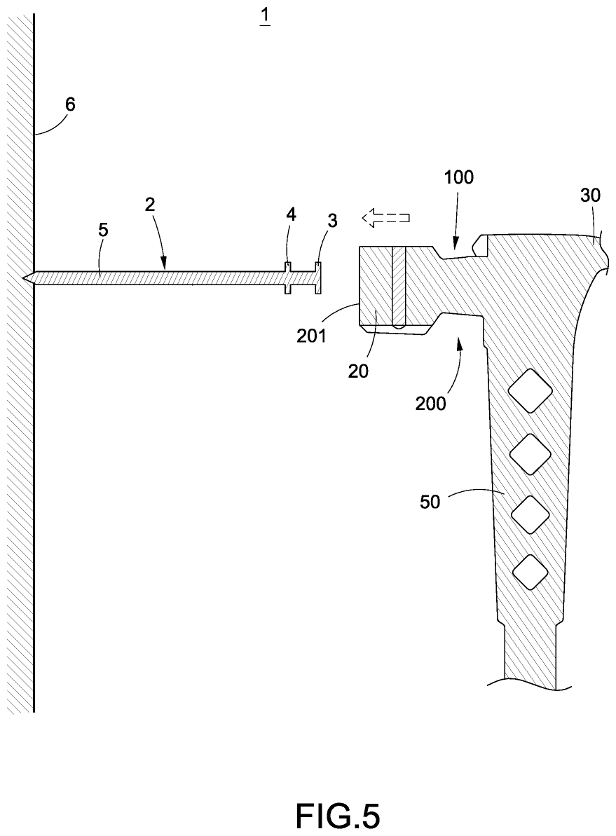

Please further refer to FIG. 4 and FIG. 5, which are schematic views illustrating operation of the hammer tool of this disclosure. As shown in FIG. 4, when the hammer tool 1 of this disclosure is used, the duplex head nail 2 is positioned in the first nail slot 100 (the upper side of the hammer head 20) of the hammer tool 1 if the fixed position (wall 6) is lower than the user's sight. Therefore, the user may exert force on the hammer tool 1 to fix the duplex head nail 2 on the wall 6 accurately.

Please refer to FIG. 5. After the duplex head nail 2 is departed from the first nail slot 100 and positioned on the wall 6, the user may hold the hammer handle 50 of the hammer tool 1 to hammer the first nail head 3 of the duplex head nail 2 with the strike face 201 of the hammer head 20. Then the end of the nail body 5 may go deeper into the wall 6 to be stably fixed on the predetermined position.

It should be noted that the duplex head nail 2 is used for objects that need to be temporarily fixed. When removing the duplex head nail 2, users may use the clamping jaw 30 of the hammer tool 1 to clamp the second nail head 4, so as to facilitate exerting force to pull out the duplex head nail 2.

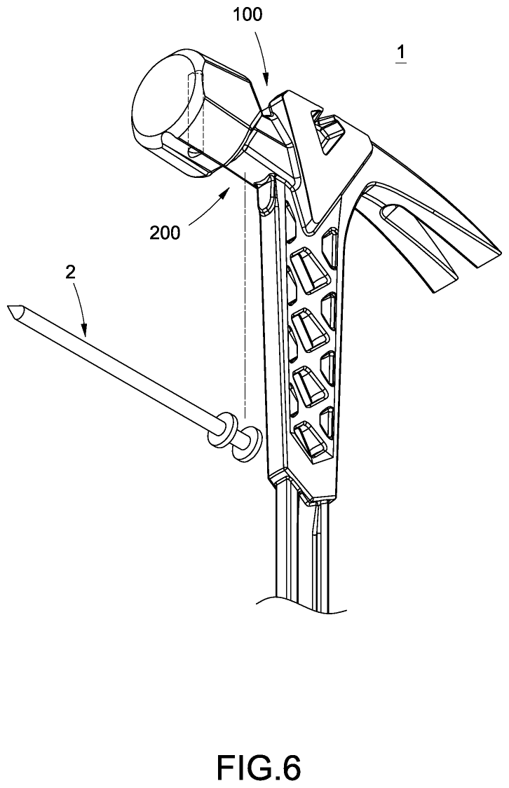

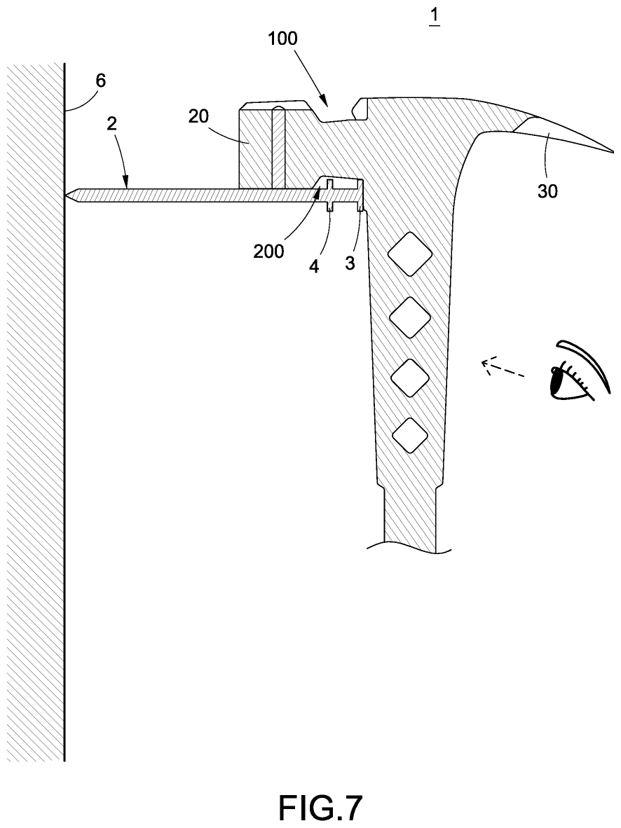

Please further refer to FIG. 6 and FIG. 7, which are another schematic views illustrating operation of the hammer tool of this disclosure. Please refer to FIG. 6, in the embodiment, the duplex head nail 2 is positioned in the second nail slot 200 of the hammer tool 1 (the lower side of the hammer head 20). Moreover, as shown in FIG. 7, the duplex head nail 2 is positioned in the second nail slot 200 (the lower side of the hammer head 20) of the hammer tool 1 when the fixed position (wall 6) is higher than the user's sight. Accordingly, the duplex head nail 2 may not be blocked by the hammer head 20 in the user's sight. As a result, the duplex head nail 2 may be hammered into the wall 6 accurately to be fixed on the predetermined position.

While this disclosure has been described by means of specific embodiments, numerous modifications and variations could be made thereto by those skilled in the art without departing from the scope and spirit of this disclosure set forth in the claims.

What is claimed is:

1. A hammer tool (1) for positioning a duplex head nail (2), the duplex head nail (2) comprising a first nail head (3) and a second nail head (4), and the hammer tool (1) comprising:
a hammer body (10), comprising a front end (11) and a rear end (12) opposite to each other, and a first abutting portion (111) and a second abutting portion (112) disposed on the front end (11) of the hammer body (10);
a hammer head (20), connected to the front end (11) of the hammer body (10), and comprising a first positioning groove (21) disposed correspondingly to the first abutting portion (111) and a second positioning groove (22) disposed correspondingly to the second abutting portion (112); and
a necked section (40), disposed between the hammer body (10) and the hammer head (20), and the necked section (40) comprising a first accommodating space (41) disposed between the first abutting portion (111) and the first positioning groove (21) and a second accommodating space (42) disposed between the second abutting portion (112) and the second positioning groove (22);
wherein, the first nail head (3) is optionally positioned in the first abutting portion (111) or the second abutting portion (112), and the second nail head (4) is located in the first accommodating space (41) or the second accommodating space along (42) with the positioning of the first nail head correspondingly.

2. The hammer tool (1) according to claim 1, wherein the first abutting portion (111) and the second abutting portion (112) are disposed on opposite sides of the hammer body (10), the first positioning groove (21) and the second positioning groove (22) are disposed on opposite sides of the hammer head (20).

3. The hammer tool (1) according to claim 1, wherein the first abutting portion (111), the first accommodating space (41) and the first positioning groove (21) are arranged linearly to configure a first nail slot (100), the second abutting portion (112), the second accommodating space (42) and the second positioning groove (22) are arranged linearly to configure a second nail slot (200).

4. The hammer tool (1) according to claim 1, wherein the first abutting portion (111) comprises a plurality of side walls (1111) located on the hammer body (10) and a bottom wall (1112) communicating with the first accommodating space (41), and a U-shaped groove is enclosed by the side walls (1111) and the bottom wall (1112).

5. The hammer tool (1) according to claim 1, further comprising: a hammer handle (50), connected to one side of the hammer body (10) and extended in a direction perpendicular to the hammer head (20), wherein the second abutting portion (112) is disposed on one side of the hammer handle (50), and the second abutting portion (112) comprises a protrusion extended from the hammer handle (50).

6. The hammer tool (1) according to claim 1, wherein the necked section (40) comprises a hexagonal prism.

7. The hammer tool (1) according to claim 5, wherein the hammer body (10), the hammer head (20) and the necked section (40) are integrally formed, or the hammer body (10) and the hammer handle (50) are disposed in one-piece form.

8. The hammer tool (1) according to claim 1, further comprising: a magnetic component (60), disposed in one-piece form and inserted to the first positioning groove (21) and the second positioning groove (22) communicating with each other, or a number of the magnetic component (60) is multiple, and the multiple magnetic components (60) are respectively arranged in the first positioning groove (21) or the second positioning groove (22) individually, and the first positioning groove (21) and the second positioning groove (22) are with a magnetic property.

9. The hammer tool (1) according to claim 8, wherein the magnetic component (60) is partially exposed from the first positioning groove (21) and the second positioning groove (22).

10. The hammer tool (1) according to claim 1, wherein the hammer head (20) comprises a strike face (201), the first positioning groove (21) and the second positioning groove (22) are extended from the strike face (201) toward the hammer head (20) respectively to communicate with the necked section (40).
